(19) United States
(12) Patent Application Publication
(10) Pub. No.: US 2002/0178166 A1
(43) Pub. Date: Nov. 28, 2002

(54) Knowledge by go business model

(75) Inventor: Matt Hsia, Laguna Niguel, CA (US)

Correspondence Address: CHARLES C.H. WU, ESQ., CHARLES C.H. WU & ASSOCIATES, APC, SUITE 710, 7700 IRVINE CENTER DRIVE, IRVINE, CA, 92618-3043, US

(73) Assignee: Direct411.com

(21) Appl. No.: 09/816,514

(22) Filed: Mar. 26, 2001

(51) Int. Cl. G06F 7/00

(52) U.S. Cl. 707/100

(57) ABSTRACT

KnowledgeByGo is a knowledge based Internet application service provider system (ASP), that tracks and analyzes browser behavior in real-time. Data analysis is delivered to the website owner or marketing agent to decide if a real time response or off line campaign needs to be initiated. KnowledgeByGo allows real-time behavioral tracking and prediction; customer relation management; one-to-one banner manager; site analysis reporting service; industry wide marketing research reports; product management; order processing; secure payment system; and customer contact manager. Subscribers get the immediate benefits of: collaborative filtering; real-time behavioral prediction; up-selling and/or cross-sell selling; banner advertisement income; Customer Relation Management (CRM); one-to-one banner management; site analysis reporting server; network-wide sales and marketing reports; product content and online pricing spidering; site management, backend product management, backend order processing, RMA processing, secured payment system, customer contact manager, price-search engine utility, and consolidated participation purchasing.

### BACKGROUND OF THE INVENTION

1. Field of the Invention

The present invention relates to methods for delivering internet and advertising to the public.

2. Description of Related Art

Knowledge of customer needs is vital in our information age. With the proliferation of Internet commerce, online behavior tracking has become vital to business success. Internet companies like as Vignette, net Genesis, and Net Perceptions have tried collaborative filtering. Collaborative filtering software aggregates and compiles purchasing information on many customers, the software then pools them into like-minded groups, and then uses the preferences of some to predict the buying habits of others.

Some e-commerce sites have implemented collaborative filtering. Amazon.com, an online bookstore, uses collaborative filtering to suggest purchases. When viewing the description of a book online, the Amazon.com website suggests additional purchases. The website states that “customers who bought this book also bought x”. Aggregating the purchasing information of many buyers, allows the Amazon.com website to suggest additional books. Collaborative filtering has many limitations and only provides focus group liked personalization that fails to respond to customer's reactions and fails to predict customer behavior.

Unfortunately, collaborative filtering does not take into account the individual habits of a consumer. Knowledge of individual personal information gives advertisers and sellers a better relationship with the customer. Individual personal information allows targeted advertising and customized offers. Unfortunately, gathering customer information is difficult. Online surveys lack accuracy and relevance to the consumer. Many state laws have restrictions on the use of personal information. Network security requirements prevent storage of certain information.

Yet even its infancy, Internet communities such as Prodigy and AOL used customer information to send targeted advertisements. If properly implemented, online behavior tracking can be a very promising marketing tool.

### SUMMARY OF THE INVENTION

One can describe Internet websites as a progression of four generations: the static site, the dynamic site, the commerce site and the personalized site.

| Generation | 1 | 2 | 3 | 4 |
|---|---|---|---|---|
| Site Type | Static | Dynamic | Commerce | Personalized |
| Goal | Presence | Interactivity | Revenue | Customer |
| | | | | Relationship |
| Complexity | Low | Medium | High | Very High |
| Intelligent | Very low | Low | Medium | High |

The invention takes the collaborative filtering paradigm to the fourth stage beyond analyzing consumer behavior. The invention allows real-time marketing that predicts a consumer's next move by knowing past behavior as well as current intentions. The invention also allows companies an effective way to market and communicate with consumers via interactive banners, messaging, etc. E-tailers can then capitalize on these capabilities by up-selling and cross-selling interactive customer services, intelligent content filtering and other services.

KnowledgeByGo is an application service provider system (ASP) providing a turnkey solution for the ECommerce industry. Subscribers get the immediate benefits of: collaborative filtering; real-time behavioral prediction; up-selling and/or cross-sell selling; banner advertisement income; Customer Relation Management (CRM); one-to-one banner management; site analysis reporting server; network-wide sales and marketing reports; product content and online pricing spidering; site management, backend product management, backend order processing, RMA processing, secured payment system, customer contact manager, price-search engine utility, and consolidated participation purchasing.

The invention would also know so much about a customer's interests and preferences that every product a customer sees will be one they really want to buy. Every visit to a website site can be a unique experience. The invention tries to redefine CRM (Customer Relationship Management) through technologies that add immediate value, and build one to one relationships.

### BRIEF DESCRIPTION OF THE DRAWINGS

FIG. 1 is a diagram of the KnowledgeByGo system and method.

FIG. 2 is a diagram of a typical KnowledgeByGo enabled website.

FIG. 3 is a diagram of a typical consumer data that is capable of being gathered by the KnowledgeByGo system and method.

### DESCRIPTION OF THE PREFERRED EMBODIMENT

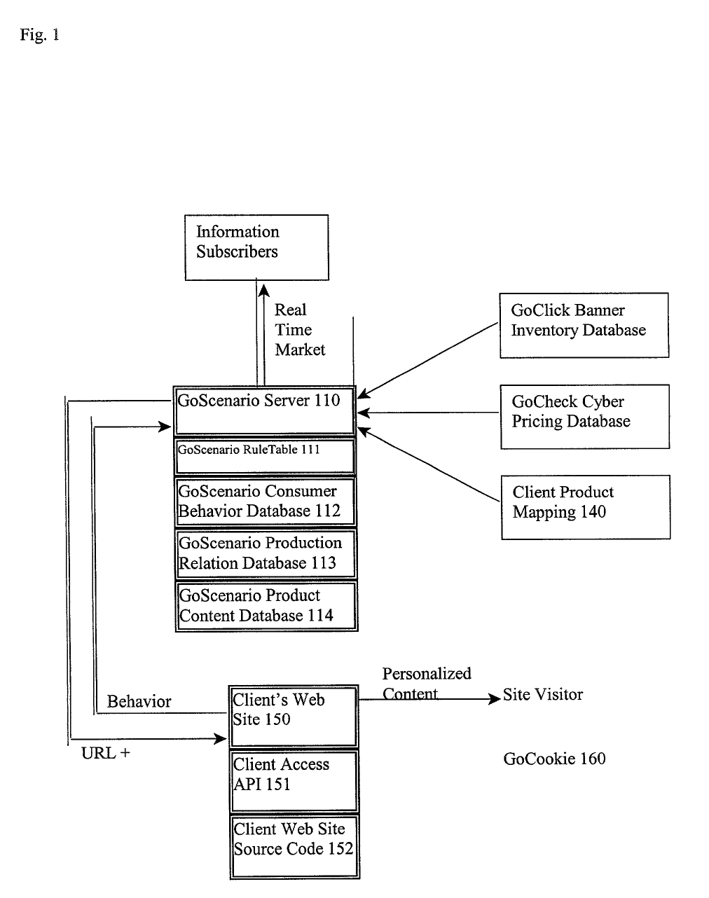

The invention is called KnowledgeByGo which is a knowledge based Internet ASP that tracks and analyzes browser behavior in real-time. The KnowledgeByGo system can be implemented on behalf of a client website FIG. 1, 150. The KnowledgeByGo system can also be internally implemented where the ‘client website’ 150 is hosted internally by the GoScenarioServer 110. Thus, the ASP Company implementing the KnowledgeByGo can host and enable its own websites.

The best mode is to host a client website and provide Application Services in the form of information and data analysis. Data analysis is delivered to the website owner or marketing agent to decide if a real time response or off line campaign needs to be initiated. KnowledgeByGo allows real-time behavioral tracking and prediction; customer relation management; one-to-one banner manager; site analysis reporting service; industry wide marketing research reports; product management; order processing; secure payment system; customer contact manager etc.

KnowledgeByGo is organized into software driven systems that handle different functions:

the WebBuilder system is an automatic e-commerce web site builder; the GoSync system provides management for the front and backend business; the GoScenario system provides real-time consumer responses to the browser; the GoClick system is a toolkit that manage the banners and listings; GoCheck that allows web content to be collected and shown as needed; the GoCookie system manages the database of users on the network. KnowledgeByGo can locally or remotely provide management for these software systems.

The operation of the KnowledgeByGo system starts with a user visiting a website. The website id's the user from the user's GoCookie (assuming the user has one computer). The id gets sent to GoSync central servers where the relevant customer info is sent back to the website. The website then takes information from GoClick, GoCheck and GoCookie and sends it to GoScenario where an administrative rule table 111 tells the ASP how to customize website visits.

### Key Systems of KnowledgeByGo

GoScenario is a hybrid combination of software and hardware that records, analyses, models, constructs and responds to past events and predicts future events in real-time. The heart of the GoScenario is the database that holds an administrative rule table 111. The administrative rule table is set to dynamically respond to an inquiry or viewing triggered from the consumers. The administrative rule table is custom configured by marketing professionals to improve sales.

The GoScenario Server 110 is comprised of the GoScenario Rule Table 111, the GoScenario Consumer Behavior Database 112, the GoScenario Production Relation Database 113, and the GoScenario Product Content Database 114.

The GoClick system manages banners. Traditional banner manager software manages and displays banner based on customer category, site, farm, and zone. GoClick tracks and reacts to an individual consumer's profile. The GoClick Banner Database 120 holds various banners that can be displayed on a Client's website 150 depending upon the analysis result given by the GoScenario Rule Table 111.

Using the example above, if Custer's customer info shows that he is more likely to mouse over certain banners such as game banners, and more likely to click on others such as music banners, then marketing strategists can program the GoScenario administrative rule table to show Custer ads that he likes. If Custer often clicks on certain icons that are not enabled, the ASP can enable a link to the icon to send him information or special offers. The GoScenario administrative rule table can be programmed to suggest any number of options. Thus, GoClick is a true one-to-one marketing vehicle identifies online consumers and push banners based on behavior and profile.

The GoCheck system spiders competitor sites to check a competitor's product content, pricing, product availability, and hot selling products. The information is verified with multiple different sources on the Internet on real-time basis. The GoCheck system FIG. 1, 130, then updates the GoScenario administrative rule table to offer competitive prices.

The GoCheck system works in conjunction with the GoSync system to enables GoScenario to give a rule as to how the customer should be given prices and product offerings.

The GoSync system is a backend enterprise management gateway that enables business information to flow transparently around enterprise, vendor, advertiser, and customer in a controlled and secure environment. It automates a wide variety of cross-enterprise processes, such as site builder, site management, traffic analyzer, online order and RMA processing, credit verification, reporting server, banner manager, distributor ordering, supply chain integration, and inventory replenishment. Here, the GoSync system would manage all elements of the invention from the GoScenario server 110 to the GoClick Banner management database 120 to the GoCheck system 130.

The GoCookie system centralizes cookie ID's FIG. 1, 160, to create a universal cookie system. GoCookie assigns cookie ID's so that GoCookie can identify a visitor when the visitor visits any of the KnowledgeByGo enabled sites. Once the user browses a KnowledgeByGo enabled web site 150, the ID number remains with the user 160. GoCookie then identifies the user at all KnowledgeByGo enabled sites without reissuing different Cookie ID numbers. Having one cookie ID number for many sites allows different sites to share their knowledge of a customer. Also, many sites have a login ID that identifies the user. The Cookie ID can also be linked to the login ID so that a user need only create and remember one login ID for the whole family of KnowledgeByGo sites.

The GoCookie system uses a GoCookie on a user's computer to determine a user's identity. The user's identity is traced to the GoScenario server that holds the customer profile. The profile has customer identity such as age, physical location, and purchasing power. Historical behavior, psychographics and demographics are also stored in the GoScenario server. Customer information can be constantly updated in real time. The database keeps track of topical interests as well as surfing patterns.

Personalized customer profiles allow a personalized website experience. If a customer profile shows that she never uses a search box, prefers text only and likes to look at the site map when she first visits a website, the ASP can query the GoScenario administrative rule table. The GoScenario administrative rule table to offer the user a customized starting page with minimal graphics, no search box and a site map navigation toolbar.

Customer profiles will show customer behavior history. One behavior is whether or not a customer watches an animated introduction to a website. Some customers like animated websites and others do not. One use of the customer profile is to predict what kind of website intro a customer wants.

Customer profiles will show customer behavior history. The history could be analyzed under the GoScenario administrative rule table under a point system. Here, a customer may lose one point for every time she skips the animated intro, and gain one point every time she wants to see the animated intro. She would want to see the animated intro if either watches it or requests it to see after visiting the main page. The administrative rule table can suggest giving her an animated intro depending upon the amount of points she has. If she is somewhere in between, the administrative rule table may suggest a shorter animation.

The administrative rule table could also help analyze the customer profile on a percentage basis. Using the example above the administrative rule table may suggest an animated intro if the customer behavior history shows that the customer wants animated intros at least a third of the time. If the customer wants animated intros only a quarter of the time, then a shorter animated intro could be played.

Implementing a marketing strategy is a fuzzy art and the philosophy of the KnowledgeByGo is sensing and responding. Thus, the administrative rule table can be set up to model a fuzzy neural model.

The administrative rule table can suggest showing offers on a combined point and percentage basis. If a customer was shown a massage chair at a shopping site and moused over it but did not click, the same offer could be shown again. Points can be given for mousing over certain items more than 50% of the instances that the item is shown. More points could be given for clicking on similar items such as massage rollers, massage books and massage tables. Even more points could be given for the purchase of a related item, membership in certain related interest associations or subscriptions in related magazines. If the user loses interest then over time the points can be depreciated using exponential decay functions similar to radioactive decay modeling.

### EXAMPLE OPERATION

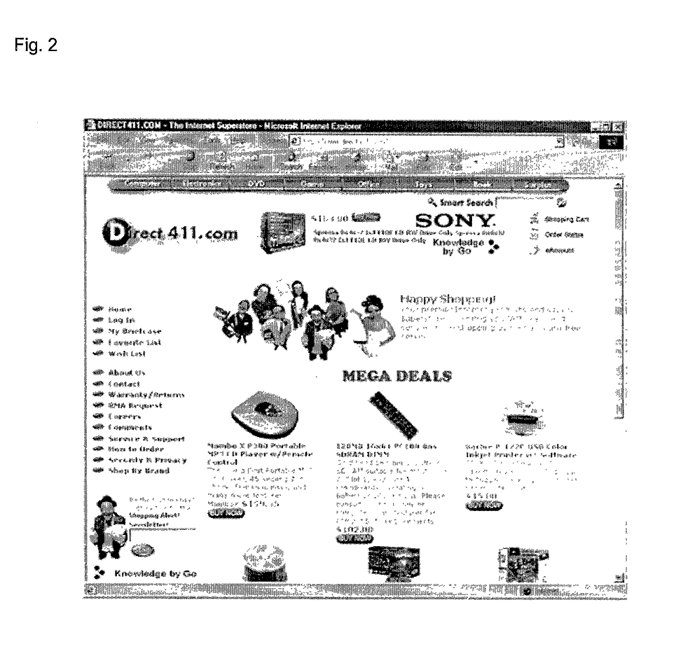

Mr. Custer Customer is a 19 year old who wants to buy a laptop computer. His father is an accountant with a subscription to accounting magazines. Custer looks through one of his father's accounting magazines and sees a laptop that he likes. Custer then visits a website such as the Direct411.com B2C site shown in FIG. 2.

He also sees an offer code in the accounting magazine that he inputs into the website when he logs on. The offer code was designed to offer accountants certain deals that appeal to accountants under a collaborative filtering scheme. Unfortunately, Custer is not an accountant and would prefer multimedia options over network compatibility options. Here, the universal cookie FIG. 1, 160 of Custer's computer would identify him and allow the GoScenario server 110 to retrieve his behavior profile 112 and lookup the GoScenario administrative rule table 111 to act intelligently. The rule table can be programmed to instruct the server 110 to direct the client's website 152 to route Custer to view multimedia enabled computers.

If Custer's customer information shows that he abandons his shopping cart 85% of the time, the GoScenario administrative rule table 111 can allow the website code 152 to deliver a personalized website 150. Here, the website would know to take steps to close the sale such as: (1) offering a simplified version of the ordering screens, (2) allocating more bandwidth and/or server resources to give him priority order processing, (3) inviting him to call a special customer phone line where special sales clerks are specially trained to close sales with indecisive and flaky customers.

If Custer were known to abandon his shopping cart only 10% of the time, the GoScenario administrative rule table 111 could suggest that the website 150 to deliver additional suggestions and product offerings in an attempt to sell additional products.

If Custer's customer information 112 shows that he is a big fan of The Grateful Dead, the GoScenario administrative rule table 111 may direct the website 150 to offer news information or an animated Banner about The Grateful Dead to keep his attention on the page while his order is processing.

The streaming real-time news information could be taken from the GoClick Banner Inventory Database 120 to be supplied to the GoScenario server 110. The GoScenario administrative rule table 111 takes into account various factors such as Custer's clicking habits to determine how much of the news to send to the client's website 150. The GoScenario Product Content Database 114 may suggest that the website 150 also offer Custer a small promotional item such as a sticker or T-Shirt with his order.

If Custer were surfing the net instead of in the process of purchasing an item, the GoClick Banner Inventory Database 120 could offer him destinations he would be interested in. When he is comparing products, and has something in his shopping cart, the GoClick Banner Inventory Database 120 need not be serving distracting ads.

If Custer's customer information shows that he always orders overnight shipping, the Client Product Mapping information 140 constantly sent to the GoScenario server 110 and stored in the GoScenario Product Content Database 114 may show a similar item at one of its local stores. Here the GoScenario administrative rule table 111 can balance the distance traveled against the added convenience and offer Custer the option of buying the same or similar laptop at the local store.

The GoCheck Cyber Pricing Database and System 130, spiders the sites of its competitors and feeds that information into the GoScenario Server 110 where is it stored in the GoScenario Product Content Database 114 along with the information from the Client Product Mapping information 140. Should a competitor offer a sale on a comparable item within the next week, Custer may feel that he overpaid. Here, the administrative rule table 111 can be programmed to suggest an ad from the GoClick Banner Inventory Database 120 so that Custer is offered a competitive retroactive instant rebate discount the next time he visits a KnowledgeByGo enabled site.

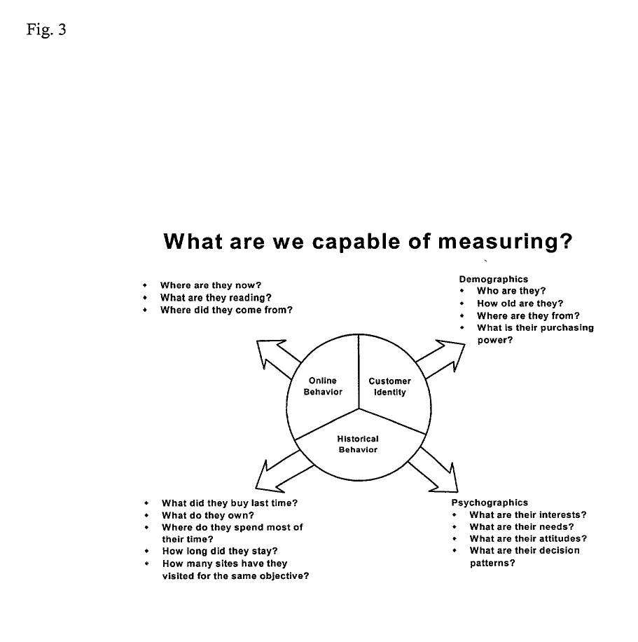

Custer's actions at KnowledgeByGo enabled sites are recorded in the Behavior Database 112. FIG. 3 shows that many aspects of the customer can be measured. Customer data is stored in the production relation database 113, and the GoScenario Consumer Behavior Database 112. The data is interpreted by GoScenario Rule Table 111.

### CONCLUSION

The KnowledgeByGo system allows website owners to customize their source code to personalize content delivery. The KnowledgeByGo system will help build an ECommerce infrastructure and ASP that licenses solutions and software to e-commerce sites and shopping related destination sites.

In return, KnowledgeByGo system can collect consumer behavior information from participants' sites. The information can generate revenue through data sharing, commissions, and advertising such as banner ad income sharing with a site owner. The KnowledgeByGo network can also deliver consumer behavior study and marketing research reporting services.

Banner advertising revenue can come from soliciting online advertisers directly or joining an established online advertisement network such as DoubleClick. GoClick can deliver personalized banner displays with the KnowledgeByGo network. Once an online user is identified, targeted banners can be displayed on the subscriber site.

1. A method of personalizing a user's website experience comprising the steps of:
a. establishing a GoSync system to administrate a computer network,
b. establishing a GoScenario system having:
i. a GoScenario administrative rule table,
ii. a GoScenario consumer behavior database, and
iii. a GoScenario product content database,
c. establishing a GoCookie system that assigns a universal cookie to website users,
d. obtaining the identity of a website user from the user's universal cookie,
e. querying individual customer information from the consumer behavior database, and product content information from the product content database,
f. sending individual customer information and product content information to the GoScenario administrative rule table wherein the GoScenario administrative rule table applies rules to produce an analysis result,
g. sending said analysis result from the GoScenario administrative rule table to a client website wherein the analysis result allows client website source code to individualize content delivery to said user.

2. The method of claim 1, further comprising the step of bartering a GoScenario market report service subscription to a website client in exchange for a client's marketing information whereby an ASP and its client share customer data.

3. The method of claim 1, further comprising the step of establishing a web builder system to provide automatic e-commerce web sites.

4. The method of claim 1, wherein step (e) further comprises the step of: querying information from a GoClick system wherein the GoClick system has:
i. a Banner Inventory Database holding various banners and information about said banners,
ii. individual user banner interaction behavior history stored in the GoScenario Consumer Behavior Database;
wherein step (f) further comprises sending GoClick information to the GoScenario administrative rule table, wherein the GoScenario Rule Table is configured to account for said GoClick information; and wherein step (g) further comprises the option of sending an individualized GoClick banner from the Banner Inventory Database to the GoScenario Server to the Client's WebSite to the user's browser.

5. The method of claim 2, wherein step (e) further comprises the step of establishing a GoCheck system comprising:
i. a GoCheck database;
ii. a GoCheck application that spiders competitor websites; gathers competitor website information; stores said information in said GoCheck database; and sends competitor pricing information, competitor product price history information, competitor product offering information, and competitor product offering history information to said GoScenario product content database.

6. The method of claim 1, wherein step (e) further comprises the step of establishing a GoCheck system comprising:
i. a GoCheck database;
ii. a GoCheck application that spiders competitor websites; gathers competitor website information; stores said information in said GoCheck database; and sends competitor pricing information, competitor product price history information, competitor product offering information, and competitor product offering history information to said GoScenario product content database.

7. A system of personalizing a user's website experience comprising:
a. a GoSync system to administrate a computer network,
b. a GoScenario system having:
i. a GoScenario administrative rule table,
ii. a GoScenario consumer behavior database, and
iii. a GoScenario product content database,
c. a GoCookie system that assigns a universal cookie to website users, and enables the GoScenario system to obtain the identity of a website user from the user's universal cookie,
d. at least one Client Web Site allowed to query individual customer information from the consumer behavior database, and product content information from the product content database, wherein said at least one Client Web Site receives an analysis result produced after individual customer information and product content information is sent to the GoScenario administrative rule table wherein the GoScenario administrative rule table applies rules to produce said analysis, wherein said at least one Client Web Site is configured to allow client website source code to individualize content delivery to said user.

8. The system of claim 7, further comprising a bartering means to barter a GoScenario market report service subscription to a website client in exchange for a client's marketing information whereby an ASP and its client share customer data.

9. The system of claim 7, further comprising a web builder system to provide automatic e-commerce web sites.

10. The system of claim 7, further comprising a GoClick system having:
i. a Banner Inventory Database holding various banners and information about said banners,
ii. individual user banner interaction behavior history stored in the GoScenario Consumer Behavior Database;
wherein GoClick information is sent to the GoScenario administrative rule table, wherein the GoScenario Rule Table is configured to account for said GoClick information; and
wherein an individualized GoClick banner can be sent from the Banner Inventory Database to the GoScenario Server to the Client's WebSite to the user's browser.

11. The method of claim 10, wherein step (e) further comprises the step of establishing a GoCheck system comprising:
i. a GoCheck database;
ii. a GoCheck application that spiders competitor websites; gathers competitor website information; stores said information in said GoCheck database; and sends competitor pricing information, competitor product price history information, competitor product offering information, and competitor product offering history information to said GoScenario product content database.

12. The method of claim 7, wherein step (e) further comprises the step of establishing a GoCheck system comprising:
i. a GoCheck database;
ii. a GoCheck application that spiders competitor websites; gathers competitor website information; stores said information in said GoCheck database; and sends competitor pricing information, competitor product price history information, competitor product offering information, and competitor product offering history information to said GoScenario product content database.
